(19) United States
(12) Patent Application Publication
(10) Pub. No.: US 2023/0081918 A1
(43) Pub. Date: Mar. 16, 2023

(54) Systems and Methods to Produce Customer Analytics

(71) Applicants: Venkat Suraj Kandukuri, Allen, TX (US); Swetha Bommisetti, Allen, TX (US)

(72) Inventors: Venkat Suraj Kandukuri, Allen, TX (US); Swetha Bommisetti, Allen, TX (US)

(73) Assignees: Venkat Suraj Kandukuri, Allen, TX (US); Swetha Bommisetti, Allen, TX (US)

(21) Appl. No.: 17/795,472

(22) PCT Filed: Feb. 10, 2021
(86) PCT No.: PCT/US2021/017347

§ 371 Date: Jul. 26, 2022

Related U.S. Application Data
(60) Provisional application No. 62/976,879, filed on Feb. 14, 2020.

(51) Int. Cl. G06Q 20/40; G06Q 20/20; G06V 40/16; G06V 10/82

(52) U.S. Cl. CPC G06Q 20/40145; G06Q 20/206; G06V 40/174; G06V 40/166; G06V 10/82

(57) ABSTRACT

An information handling system may include a processor; a memory; a power management unit to provide power to the information handling system; a video camera to acquire video images of a customer at a point-of-sale (POS) location; a facial recognition system to execute a facial recognition module at the POS location to detect the face of the customer and determine an emotion of the customer; a video deletion module to delete the video images of the customer when the face of the customer is detected and the emotion is determined.

### RELATED APPLICATIONS

The present application claims the benefit of U.S. Provisional Application Ser. No. 62/976,879 entitled HASSLEFREE CUSTOMER ANALYTICS, which was filed on Feb. 14, 2020. The foregoing application is incorporated by reference as though set forth herein in its entirety. the disclosure of which is incorporated herein by the reference in its entirety.

### FIELD OF THE DISCLOSURE

The present disclosure generally relates to customer analytics. The present disclosure more specifically relates to gathering customer analytics in at a point-of-sale location.

### ACKGROUND

Information related to business development has increased in value especially due to recent developments in systems capable of obtaining this data. One option available to a user is an information handling system. An information handling system generally processes, compiles, stores, and/or communicates information or data for business, personal, or other purposes thereby allowing clients to take advantage of the value of the information. Because technology and information handling processes may vary between different intended uses, information handling systems may also vary regarding what information is handled, how the information is handled, how much information is processed, stored, or communicated, to whom the information is provided to if at all, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an information handling system deployed with one or more video cameras according to an embodiment of the present disclosure;

FIG. 3 is a block diagram depicting a graphical user interface (GUI) presented to a user during operation of the information handling system according to an embodiment of the present disclosure;

FIG. 4 is a block diagram depicting a GUI presented to a user during operation of the information handling system according to another embodiment of the present disclosure;

FIG. 5 is a block diagram depicting a GUI presented to a user during operation of the information handling system according to another embodiment of the present disclosure;

FIG. 6 is a block diagram depicting a GUI presented to a user during operation of the information handling system according to another embodiment of the present disclosure;

FIG. 7 is a block diagram depicting a GUI presented to a user during operation of the information handling system according to another embodiment of the present disclosure;

FIG. 8 is a block diagram depicting a GUI presented to a user during operation of the information handling system according to another embodiment of the present disclosure;

FIG. 9 is a flow diagram illustrating a method of monitoring point-of-sale (POS) contact according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Embodiments of the present disclosure provide for a system and method of monitoring point-of-sale (POS) contacts at a POS location. This POS location may include any physical location where a customer interfaces with an employee or owner of the POS location during commerce. Examples of a POS location may include any retail sales location, a financial institution such as a bank, a service-oriented location such as a hair salon, an amusement park, or an auto repair shop, among other locations where consumers of goods and services meet face-to-face with employees or owners of the POS locations. The POS contacts monitored by the system and per the execution of the method described herein may be accomplished by a facial recognition system that recognizes individual customers' faces and the demographics of those customers. The facial recognition system may also be configured to detect an emotion of a customer at the POS location, while engaged in a conversation with an employee, and during a sale of merchandise or while services are being performed on behalf of the customer. These emotions may vary based on the customers' reactions to the services provided or goods sold and is an indicator to the owner of the POS location that customers are or are not reacting to their services provided.

The embodiments of the present disclosure also provide for customer data privacy preventing personal details about a specific customer from being used. Instead, in an embodiment, the system and methods deliberately delete any video images of a customer and prevents any specific video images from being sent over a network to, for example, a cloud server. Instead, the present systems and method described herein, evaluates the video images, in real-time or at a later time (e.g., daily, weekly, monthly), to detect the demographics and emotion data from those images and deletes the images. The demographics and emotion data may, therefore, be scrubbed of any personal details of specific customers and presented to a user of the system and method as generalized demographic and emotion data.

In an embodiment, a trained neural network or any other suitable algorithm may be implemented to detect the specific emotion of a customer during a sale at the POS location. These emotions may include, for example, anger, disgust, fear, happy, neutral, sad, and surprise, among others. By inputting details about the customers' images into the trained neural network, the neural network may be capable of detecting the emotion felt by a customer during sales interactions within the POS location. By detecting these emotions, the user of the system and method may determine whether, for example, a sale on goods and services is increasing sales. The user may also set conditions, based upon these detected emotions, as to whether the customer should be sent a coupon or other promotional items in order to further incentivize the customer to return to the POS location. Other remedial actions may be initiated by the owner of the POS location and the system described herein in order to increase sales at their POS location.

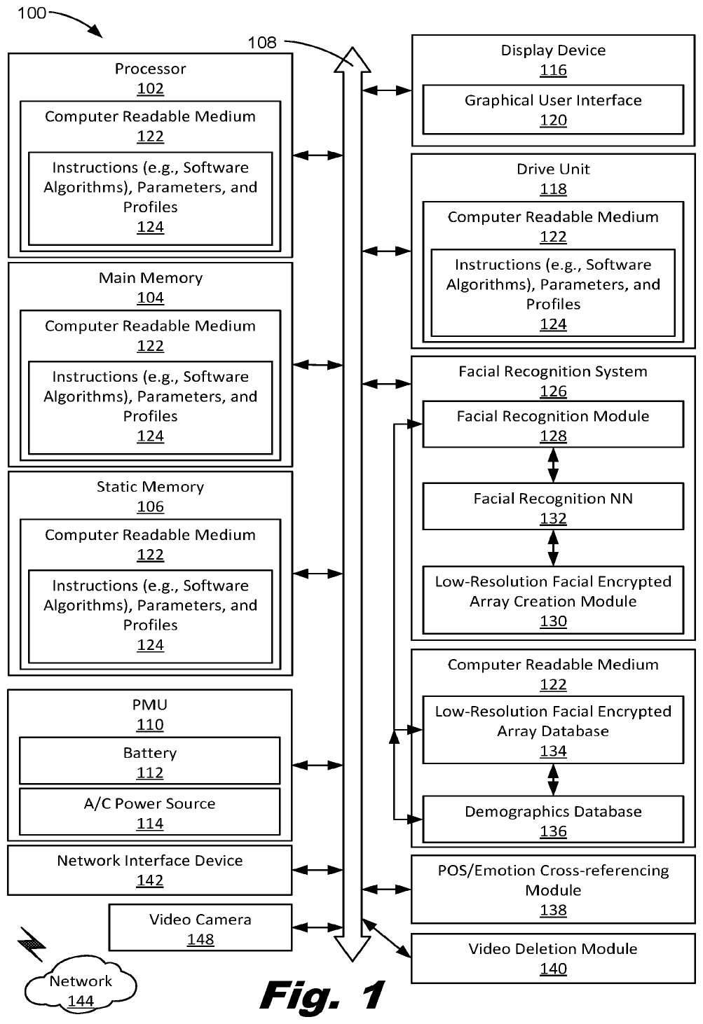

FIG. 1 illustrates an information handling system 100 similar to information handling systems according to several aspects of the present disclosure. In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP), a base station transceiver, a wireless telephone, a land-line telephone, a control system, a video camera, a scanner, a facsimile machine, a printer, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server, as a client computer in a server-client network environment, as an edge computing device (e.g., processing and data storage resources placed closer to the information handling system 100 to improve processing throughput), or as a peer computer system in a peer-to-peer (or distributed) network environment. In these embodiments, and in following with the principles described herein, the information handling system 100 is prevented from transmitting any personal data linked to specific customers detected at a POS location, but may otherwise transmit general data from device to device or outside of a network installed in a POS location. Additionally, the information handling system may communicate with various servers outside the network formed within the POS location in order to retrieve various software and firmware updates as described herein. Thus, the presently-described information handling system 100 may operate while connected to a network to provide internet connectivity, but due to the sensitive nature of the data collected by the information handling system 100 (e.g., video images), is otherwise prevented from such transmissions of this sensitive data.

In a particular embodiment, the information handling system 100 can be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

The information handling system can include memory (volatile (e.g., random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system 100 can include one or more storage devices, one or more communications ports for communicating with external devices, as well as, various input/output (I/O) devices, such as a keyboard, a mouse, a video/graphic display, a video camera 148, or any combination thereof. The video camera 148 may by any of an infrared (IR) camera, a mirrorless camera, a digital single-lens reflex (DSLR) camera, an action camera, a 360-degree camera, or a combination of these types of cameras, among others. The information handling system 100 can also include one or more buses 108 operable to transmit communications between the various hardware components. Portions of an information handling system 100 may themselves be considered information handling systems 100 in an embodiment.

Information handling system 100 can include devices or modules that embody one or more of the devices or execute instructions for the one or more systems and modules described herein, and operates to perform one or more of the methods described herein. The information handling system 100 may execute code instructions 124 that may operate on servers or systems, remote data centers, or on-box in individual client information handling systems according to various embodiments herein. In some embodiments, it is understood any or all portions of code instructions 124 may operate on a plurality of information handling systems 100.

The information handling system 100 may include a processor 102 such as a central processing unit (CPU), control logic or some combination of the same. Any of the processing resources may operate to execute code that is either firmware or software code. Moreover, the information handling system 100 can include memory such as main memory 104, static memory 106, computer readable medium 122 storing instructions 124 of a facial recognition system 126 and its associated facial recognition neural network (NN) 132, a low-resolution facial encrypted array creation module 130, a POS/emotion cross-referencing module 138, a video deletion module 140, and drive unit 116 (volatile (e.g. random-access memory, etc.), nonvolatile (read-only memory, flash memory etc.) or any combination thereof). The information handling system 100 can also include one or more buses 108 operable to transmit communications between the various hardware components such as any combination of various input/output (I/O) devices and the processor 102.

The information handling system 100 may further include a display device 110. In the embodiments herein, the display device 110 may present a graphical user interface (GUI) 120 to a manager or other user of the information handling system in order to receive demographic and emotion data described herein. The display device 110 in an embodiment may function as a liquid crystal display (LCD), an organic light emitting diode (OLED), a flat panel display, a solid-state display, or a cathode ray tube (CRT). Additionally, the information handling system 100 may include an input device, such as a cursor control device (e.g., mouse, touchpad, or gesture or touch screen input, and a keyboard. The information handling system 100 can also include a disk drive unit 116. In an embodiment, the GUI 120 may be presented to a user using a web-based application accessed by any of the types of information handling systems 100 (e.g., a mobile device) described herein. These GUIs may be accessed, in an embodiment, by accessing a web page of a website (e.g., accessible by password or other credentials) via execution of a web browser application on the information handling system.

The network interface device 142 can provide connectivity to a network 144, e.g., a wide area network (WAN), a local area network (LAN), wireless local area network (WLAN), a wireless personal area network (WPAN), a wireless wide area network (WWAN), or other networks. Connectivity may be via wired or wireless connection. The network interface device 142 may operate in accordance with any wireless data communication standards. To communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, one network interface device 142 may operate two or more wireless links.

The network interface device 142 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers, which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac (e.g., center frequencies between 5.170-5.785 GHz). It is understood that any number of available channels may be available under the 5 GHz shared communication frequency band. WLAN, for example, may also operate at a 2.4 GHz band. WWAN may operate in a number of bands, some of which are proprietary but may include a wireless communication frequency band at approximately 2.5 GHz band for example. In additional examples, WWAN carrier licensed bands may operate at frequency bands of approximately 700 MHz, 800 MHz, 1900 MHz, or 1700/2100 MHz for example as well.

In some embodiments, software, firmware, dedicated hardware implementations such as application specific integrated circuits (ASICs), programmable logic arrays and other hardware devices can be constructed to implement one or more of some systems and methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionalities as described herein.

The present disclosure contemplates a computer-readable medium that includes instructions, parameters, and profiles 124 or receives and executes instructions, parameters, and profiles 124 responsive to a propagated signal, so that a device connected to a network 144 can communicate voice, video or data over the network 144. Further, the instructions 124 may be transmitted or received over the network 144 via the network interface device 142 or a wireless adapter.

The information handling system 100 can include a set of instructions 124 that can be executed to cause the computer system to perform any one or more of the methods or computer-based functions disclosed herein. For example, instructions 124 may execute a facial recognition system 126, a facial recognition neural network 132, a low-resolution facial encrypted array creation module 130, a POS/emotion cross-referencing module 138 a video deletion module 140, software agents, or other aspects or components. Various software modules comprising application instructions 124 may be coordinated by an operating system (OS), and/or via an application programming interface (API). An example operating system may include Windows®, Android®, and other OS types. Example APIs may include Win 32®, Core Java® API, or Android® APIs.

The disk drive unit 118 and the facial recognition system 126, the low-resolution facial encrypted array creation module 130, the POS/emotion cross-referencing module 138, and the video deletion module 140 may include a computer-readable medium 122 in which one or more sets of instructions 124 such as software can be embedded. Similarly, main memory 104 and static memory 106 may also contain a computer-readable medium for storage of one or more sets of instructions, parameters, or profiles 124. The disk drive unit 116 and static memory 106 may also contain space for data storage. Further, the instructions 124 may embody one or more of the methods or logic as described herein. For example, instructions relating to the facial recognition system 126, the facial recognition neural network 132, the low-resolution facial encrypted array creation module 130, the POS/emotion cross-referencing module 138, and the video deletion module 140 as well as any associated software algorithms, processes, and/or methods may be stored here. In a particular embodiment, the instructions, parameters, and profiles 124 may reside completely, or at least partially, within the main memory 104, the static memory 106, and/or within the disk drive 116 during execution by the processor 102 of information handling system 100. As explained, some or all of the facial recognition system 126, the facial recognition neural network 132, the low-resolution facial encrypted array creation module 130, the POS/emotion cross-referencing module 138, and the video deletion module 140 may be executed locally or remotely. The main memory 104 and the processor 102 also may include computer-readable media.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The facial recognition system 126, the facial recognition neural network 132, the low-resolution facial encrypted array creation module 130, the PO S/emotion cross-referencing module 138, and/or the video deletion module 140 may be stored in static memory 106, or the drive unit 116 on a computer-readable medium 122 such as a flash memory or magnetic disk in an example embodiment. While the computer-readable medium is shown to be a single medium, the term “computer-readable medium” includes a single medium or multiple media such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100, as mentioned, may include a facial recognition system 126 that may be operably connected to the bus 108. The computer readable medium 122 associated with the facial recognition system 126 may also contain space for data storage. The facial recognition system 126 may, according to the present description, perform tasks related to receiving video data or images from one or more video cameras 148 and executing a low-resolution facial encrypted array creation module 130 to create a low-resolution facial encrypted array describing features of any customer at the POS location described herein. In creating the low-resolution facial encrypted arrays, the demographics of the customer at the POS location may also be determined. The facial recognition system 126 may also execute a POS/emotion cross-referencing module 138 that determines an emotion of a customer at the POS location.

In an embodiment, the facial recognition system 126 may detect the face of a customer from a video image. In the embodiments herein, the video cameras 148 may be placed at a location where a facial view of the customer may be captured. For example, the video cameras 148 may be placed within a business much like security cameras. In a specific embodiment, the video cameras 148 may be security cameras configured to also capture the video images for the facial recognition system 126. Additionally, or alternatively, the video cameras 148 may be a webcam used by a user at the information handling system 100 to engage in online commerce. In this embodiment, the webcam may be used to capture the video images for the facial recognition system 126.

The detection of the face of the customer may be performed by, for example, executing a feature-based facial detection process or an image-based facial detection. The feature-based facial detection process may include one or more image filters that search for and locate faces in a video image (e.g., a video frame) using, for example, a principal component analysis. In this embodiment, a number of “eigenfaces” are determined based on global and orthogonal features in other known images that include human faces. A human face may then be calculated as a weighted combination of a number of these eigenfaces.

Alternatively, and in the context of the embodiments described herein, a facial recognition neural network 132 is used. In these embodiments, the facial recognition neural network 132, in an embodiment, may be an untrained neural network that learns, holistically, how to detect and extract faces from the video images. The neural network may implement any machine learning techniques such as a supervised or unsupervised machine learning technique to identify faces within the video image. In an embodiment, a neural network of the facial recognition system 126 may be separately trained for each information handling system (e.g., including 100) used to detect the presence and identity of a customer. The facial recognition neural network 132 may receive, as input, a plurality of video images either from the video camera 148 at the POS location or from a databased accessible by the information handling system 100.

Training of the facial recognition neural network 132 may include inputting the video images into the facial recognition neural network 132 that includes a plurality of layers, including an input layer, one or more hidden layers, and an output layer. The video images may form the input layer of the neural network in an embodiment. These input layers may be forward propagated through the neural network to produce an initial output layer that includes predicted faces within the video images. Each of the output nodes within the output layer, in an embodiment, may be compared against such known values (e.g., images known to have faces) to generate an error function for each of the output nodes. This error function may then be back propagated through the neural network to adjust the weights of each layer of the neural network. The accuracy of the predicted meeting metric values (as represented by the output nodes) may be optimized in an embodiment by minimizing the error functions associated with each of the output nodes. Such forward propagation and backward propagation may be repeated serially during training of the neural network, adjusting the error function during each repetition, until the error function for all of the output nodes falls below a preset threshold value. In other words, the weights of the layers of the neural network may be serially adjusted until the output node for each of the video images accurately predicts the presence of a face in the video image. In such a way, the neural network may be trained to provide the most accurate output layer, including a prediction of the existence of a face in the video image.

In an embodiment, the facial recognition neural network 132 may be trained prior to deployment in the information handling system 100. In this embodiment, the trained facial recognition neural network 132 may be trained by an information handling system that is operatively coupled to the information handling system 100 deployed at the POS location via a network. In this embodiment, the trained facial recognition neural network 132 may be sent to the information handling system 100 for execution by the processor there and updated occasionally to increase the efficiency of the execution of the facial recognition neural network 132.

In an embodiment, once the face within a video image has been detected, the face may be tracked over a plurality of video images as the customer travels throughout the POS location using the facial recognition system 126. As this occurs, the facial recognition system 126 may also execute a face alignment process that normalizes the face using geometry and photometrics processes. This normalization of the customer's face may then allow the facial recognition system 126 to extract features from the detected faces that are used later to recognize a customer as either a new customer (e.g., “unknown face”) or a repeat customer (e.g., a “known face”) at the POS location.

The extracted facial features may include any number of distinctive features of any users' face that are distinguishable among facial images. In this embodiment, the facial recognition system 126 may identify facial features by extracting landmarks, or features, from an image of the subject's face. For example, any algorithm may analyze the relative position, size, and/or shape of the eyes, nose, cheekbones, and jaw and provide a list of distinguishing measurements to be associated with each individually-identified customer. In some embodiments, the extracted features may include a distance between pupils of a customer's eyes, distances between interior edges of the customer's eyes, distances between exterior edges of the customer's eyes, placement of the customer's nose relative to other features on the customer's face, location of the customer's eyes relative to other features on the customer's face, location of the cheekbones relative to the customer's jaw, or any number of measured lengths between these features.

In an embodiment, the facial recognition system 126 may communicate with the main memory 104, the processor 102, the video display 110, the alpha-numeric input device 112, and the network interface device 120 via bus 108, and several forms of communication may be used, including ACPI, SMBus, a 24 MHZ BFSK-coded transmission channel, or shared memory. Keyboard driver software, firmware, controllers and the like may communicate with applications on the information handling system 100.

The information handling system 100, as mentioned, may include a low-resolution facial encrypted array creation module 130 that may be operably connected to the bus 108. The computer readable medium 122 associated with the low-resolution facial encrypted array creation module 130 may also contain space for data storage. The low-resolution facial encrypted array creation module 130 may, according to the present description, perform tasks related to generating a low-resolution facial encrypted array of each of the faces of the customers detected at the POS location. In an embodiment, the extracted features of each of the customers' faces may be used to create these low-resolution facial encrypted arrays. For example, the arrays may include distance and vector values that define the features and placement of those features of each customer's face. These distance and vector values may be stored on a low-resolution facial encrypted array database 134 for future use by the information handling system 100.

At this point, the stored low-resolution facial encrypted arrays stored on the low-resolution facial encrypted array database 134 are not associated with a specific customer detected by the information handling system 100. In an embodiment, these low-resolution facial encrypted arrays may be associated with a specific customer via execution of the cross-referencing module 138. In this embodiment, the cross-referencing module 138 may receive POS data describing the individual customers' names at the time of purchase of a good or service at the POS location. This cross-referencing may be accomplished by noting the time the transaction took place between the customer and the POS location as well as the time stamp of the video image used to extract the facial features and generate the low-resolution facial encrypted arrays with. At this point the low-resolution facial encrypted array database 134 may store the individual customers' along with the detected low-resolution facial encrypted arrays associated with those customers. This allows the information handling system 100 to execute the facial recognition system 126 and cross-referencing module 138 concurrently in order to compare any detected facial features (e.g., any created low-resolution facial encrypted arrays) with those maintained on the low-resolution facial encrypted array database 134 to determine whether the detected face of the customer is new to the POS location (e.g., unique) or a returning customer. In an embodiment where no cross-referencing may be accomplished by the system in order to identify a specific low-resolution facial encrypted array with a specific identification of that user, the facial recognition system 126 and cross-referencing module 138 may still identify if a customer is a returning customer or a new customer. The POS/emotion cross-referencing module 138 may be used to accomplish this process. In this embodiment, the POS/emotion cross-referencing module 138 may identify a returning customer by matching a low-resolution facial encrypted array obtained at the point of identification by the facial recognition system 126 with another low-resolution facial encrypted array stored on the low-resolution facial encrypted array database 134. Where a match exists, the customer is indicated as a returning customer. Where no such match is obtained, the customer is indicated as a new customer. In an embodiment, the use of promotional items for any customer may vary and depend on whether the customer is a returning customer or a new customer. In an embodiment, the low-resolution facial encrypted arrays may be maintained during the length of operation of the information handling system 100. In alternative embodiments, some low-resolution facial encrypted arrays may be deleted after a threshold period of time to provide additional storage at the low-resolution facial encrypted array database 134 and reduce the number of low-resolution facial encrypted arrays to compare any subsequently-created low-resolution facial encrypted arrays with.

In an embodiment, the low-resolution facial encrypted array creation module 130 may communicate with the main memory 104, the processor 102, the video display 110, the alpha-numeric input device 112, and the network interface device 120 via bus 108, and several forms of communication may be used, including ACPI, SMBus, a 24 MHZ BFSK-coded transmission channel, or shared memory. Keyboard driver software, firmware, controllers and the like may communicate with applications on the information handling system 100.

The information handling system 100, as mentioned, may include a demographics database 136 that may be operably connected to the bus 108. The computer readable medium 122 associated with the demographics database 136 may also contain space for data storage and specifically data storage related to the demographics of the user. The demographics database 136 may, according to the present description, receive demographic data associated with each customer as determined by the facial recognition system 126 and low-resolution facial encrypted array creation module 130. In a specific, embodiment, the facial recognition neural network 132 of the facial recognition system 126 may be trained to determine whether the detected faces include, for example, a male or female. The facial recognition neural network 132 may also determine a general age of the customer in an embodiment. Still further, the facial recognition neural network 132 may determine any other relevant demographics that may aid the user of the information handling system 100 to increase sales at the POS location.

In another embodiment, the data created by the low-resolution facial encrypted array creation module 130 may be used to determine these demographics of the customers based on the extracted facial features and created low-resolution facial encrypted arrays. In this embodiment, the extracted low-resolution facial encrypted arrays may indicate which gender or age the customer is along with these other demographics. For example, certain measurements in the data of the low-resolution facial encrypted arrays may be used to distinguish between male and female features of the customers' faces. Although, in some embodiments, this may not be definitive of which demographics to assign to each customer, the data received from the low-resolution facial encrypted arrays may assign a probability of certain demographics of an individual customer which, with the output from the facial recognition neural network 132, may determine the demographics of the individual customers more accurately.

The information handling system 100, as mentioned, may include a POS/emotion cross-referencing module 138 that may be operably connected to the bus 108. The computer readable medium 122 associated with the POS/emotion cross-referencing module 138 may also contain space for data storage. The POS/emotion cross-referencing module 138 may, according to the present description, perform tasks related to determining a customer's emotion during a transaction at the POS location. In an embodiment, the video camera 148 may detect the face of a customer while the customer is within the POS location, actively talking with an employee of the POS location, and/or engaged in a transaction such as an over-the-counter transaction. In an embodiment, the distance between the employee and a customer may also be detected by the video camera 148 in order to determine whether a conversation is being conducted or not. In these embodiments, the POS/emotion cross-referencing module 138 may implement the features of the facial recognition neural network 132 to extract a detected emotion from the video images presented by the video camera 148 at any time while the customer is in the POS location. This may be done by, again, using the individual video images as input into the facial recognition neural network 132 and receiving, as output, a detected emotion. Again, the video images may form the input layer of the neural network. These input layers may be forward propagated through the neural network to produce an initial output layer that includes predicted emotions of the customer or customers within the video images. Each of the output nodes within the output layer, in an embodiment, may be compared against such known values (e.g., images known to include specific emotions of a customer) to generate an error function for each of the output nodes. This error function may then be back propagated through the neural network to adjust the weights of each layer of the neural network. The accuracy of the predicted meeting metric values (as represented by the output nodes) may be optimized in an embodiment by minimizing the error functions associated with each of the output nodes. Such forward propagation and backward propagation may be repeated serially during training of the neural network, adjusting the error function during each repetition, until the error function for all of the output nodes falls below a preset threshold value. In other words, the weights of the layers of the neural network may be serially adjusted until the output node for each of the video images accurately predicts the presence of one or more emotions of a customer within the video image. In such a way, the neural network may be trained to provide the most accurate output layer, including a prediction of the existence of emotions experienced by the customer in order to gauge how the customer is feeling within the POS location. In these embodiments, the emotions of the customers may indicate to an owner of the POS location and operator of the information handling system that a customer is angry for some reason (e.g., poor customer service, high prices, etc.), disgusted, fearful, happy, neutral, sad, or surprised among a plurality of other possible emotions. Again, the training of the facial recognition neural network 132 may dictate the accuracy of the emotions detected and as the facial recognition neural network 132 is trained, this accuracy may increase. As such, the information handling system 100 may increase the accuracy at which it detects the facial features of a customer as well as the emotions of those customers. In an embodiment, once the emotions of the customers are detected, the emotions experienced by each individual customer throughout the customers' presence within the POS location.

In an embodiment, the facial recognition system 126 with its facial recognition neural network 132 may also detect the presence of an employee of the POS location. This data may be deliberately added to the low-resolution facial encrypted array database 134 after the facial recognition system 126 has created the low-resolution facial encrypted arrays of the employees' faces via the low-resolution facial encrypted array creation module 130. In these examples, the POS/emotion cross-referencing module 138 may be implemented to disregard the emotions detected and demographics associated with these employees so that only data from customers visiting the POS location is received and provided to the user of the information handling system (e.g., an owner/operator of the POS location).

In an embodiment where the facial recognition system 126 includes an untrained facial recognition neural network 132, the emotions of the employees may also be extracted with the creation of a low-resolution facial encrypted array and identified as a “known face” to be associated with each employee. In this embodiment, the low-resolution facial encrypted array database 134 may maintain these detected emotions and low-resolution facial encrypted array. During operation of the information handling system 100, the low-resolution facial encrypted arrays associated with the employees may be filtered out so that the data presented on the GUIs described herein do not include this data associated with the employees. In this embodiment, the low-resolution facial encrypted arrays associated with the employees may also be used to further train the facial recognition neural network 132 in order to receive better output results.

In an embodiment, the POS/emotion cross-referencing module 138 may communicate with the main memory 104, the processor 102, the video display 110, the alpha-numeric input device 112, and the network interface device 120 via bus 108, and several forms of communication may be used, including ACPI, SMBus, a 24 MHZ BFSK-coded transmission channel, or shared memory. Keyboard driver software, firmware, controllers and the like may communicate with applications on the information handling system 100.

In an embodiment, the information handling system 100 includes a video deletion module 140. In order to maintain privacy related to the customer's, the video deletion module 140 may delete any video images or video content that includes an image of the customers. In this embodiment, the facial recognition neural network 132 may send a signal to the video deletion module 140 that the low-resolution facial encrypted array creation module 130 has created the low-resolution facial encrypted arrays and stored those low-resolution facial encrypted arrays on the low-resolution facial encrypted array database 134. When this occurs, the information handling system 100 maintains sufficient information to recognize a new or returning customer by comparing any newly created low-resolution facial encrypted arrays to those stored on the low-resolution facial encrypted array database 134. Because, in an embodiment, the low-resolution facial encrypted arrays are encrypted using any encryption method, the low-resolution facial encrypted arrays may not be accessed by any other networked device without having access to, for example, a decryption key. When the video deletion module 140 receives this signal that these low-resolution facial encrypted arrays have been created and stored, the video deletion module 140 may delete any and all video images and notify the facial recognition system 126 that this has occurred. Again, this protects any customers' privacy while still allowing a user and owner of the information handling system 100 to receive demographic data and emotion data associated with each customer.

As described herein, the information handling system 100 may be deployed at any POS location. This may include hotels (e.g., hospitality industries), hospitals, movie theaters, car dealerships, restaurants, automobiles (e.g., ride share commerce), gas stations, among other businesses where a customer interacts with an employee or where a customer's face is viewable via a video camera (e.g., teleconferencing, online schooling, online sales, telemedicine and virtual healthcare scenarios). Additionally, the present information handling system may be used to determine a return on investment (ROI) when improvements to the business is updated with new or better services or goods. In some embodiments, not only may the facial recognition system 126 of the information handling system 100 detect the demographics and emotions of the customers, the facial recognition may facilitate any criminal investigations or alter a user of those persons who are not allowed to be on the premises such as those who had previously been trespassed. The information handling system 100 may further be used by the user to train employees and provide feedback to those employees as to how to better interact with customers. Still further, the data received from the information handling system 100 by the user (e.g., via a number of GUIs) may indicate more targeted marketing necessary to increase sales at the POS location. Even further, the data received from the information handling system 100 by the user (e.g., via a number of GUIs) may indicate any potential wait times for customers at, for example, a fast-food restaurant where the information handling system is deployed.

The information handling system 100 allows the user to rely on more accurate, real-time data related to customer satisfaction instead of relying on later-received and potentially inaccurate reviews on websites such as Yelp®, Bing®, Angie's List®, among review websites and applications. Additionally, the information handling system 100 described herein alleviates the need for customers to fill out surveys during or after the interaction at the POS location. This further reduces any incentives necessary to have those customers fill out the survey, answer feedback calls, or otherwise relate their experience regarding a transaction that occurred in the past. By eliminating the need for customers to fill out surveys later and after a significant time has passed, the data provided by the information handling system 100 and the operation of the facial recognition system 126 provides relatively more accurate review score calculations than the typical “5-star” review calculations. Additionally, the user of the information handling system 100 may be made aware of those interactions that need to be improved, those employees who need additional training, which goods or services sell better, and how any changes to the goods and services offered for sale may affect the income produced at the POS location. Additionally, the operation of the information handling system 100 as described herein, the owner of the POS location may better engage in loyalty campaigns and better tailor those loyalty programs based on the emotions experienced by any customer in real-time and even when the customer is currently purchasing a good or service. For example, where a customer experiences disgust, anger, or sadness at the POS location, the owner of the POS location may decide to have the information handling system 100 to automatically increase the loyalty benefits to that specific customer in order to entice that customer to return again for a second visit.

Still further, instead of relying on the review websites and applications to receive reviews from customers, the presently-described information handling system 100 captures all customers' emotions and demographics. Indeed, where a new person enters the POS location, their demographic data and emotions experienced are captured and provided to the user of the information handling system 100.

Via the execution of the information handling system 100 and the methods described herein, an owner of the POS location may further determine answers to a myriad of sales questions. For example, where the owner would like to know at what time of day or what days of the week the POS location is busy with customers, the number of distinct facial recognitions over a period of time may be provide to the user to answer such a question. Additionally, where the owner has improved the POS location by, for example, installing a juice bar to attract a certain demographic of customers, the facial recognition system 126 may detect which and how many customers interacts with these new improvements, what additional goods or services are sold, and how to better staff the new improvements in order to adjust the general operations of the POS location accordingly. Still further, the owner may, through the detection of children being brought into the POS location, the owner may determine to increase the focus of goods and services sold to accommodate those ages of customers. Even further, the owner may be able to know which of the employees interact best with customers based on the customers' detected emotions. In this example, the employer/owner of the POS location may better be able to determine which employees to promote, which employees to fire, and which employees should otherwise benefit from their good behavior and customer relations.

In an embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. In an embodiment an information handling system 100 may include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

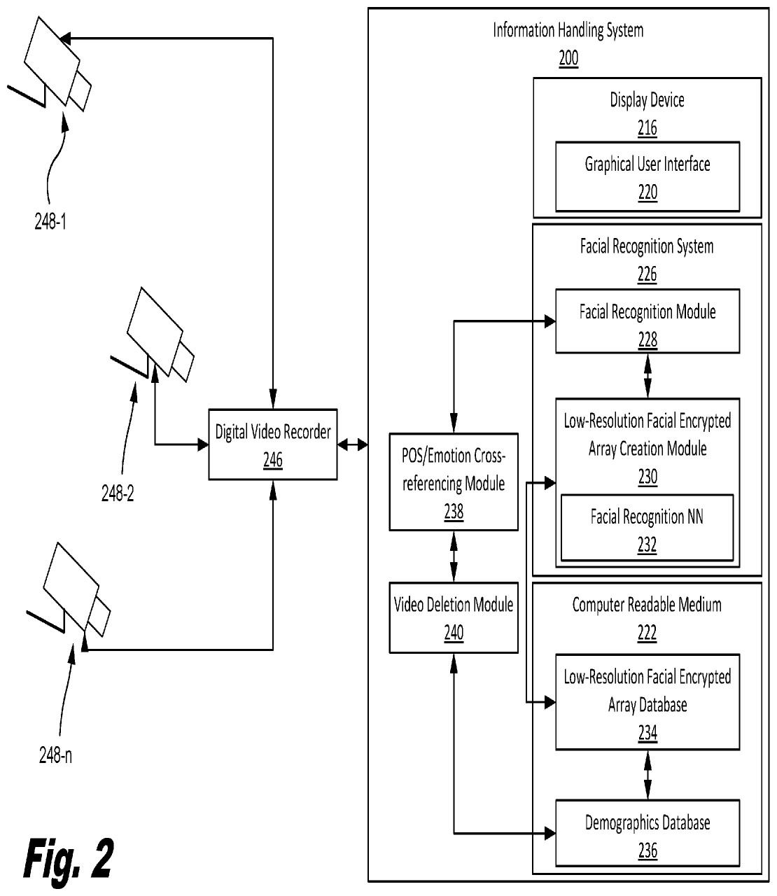

FIG. 2 is a block diagram illustrating an information handling system 200 deployed with one or more video cameras 248-1, 248-2, 248-n according to an embodiment of the present disclosure. As described herein, the information handling system 200 may be deployed at a POS location in order to detect the demographics and emotions of any customer entering the POS location. In order to accomplish this, the information handling system 200 is operatively coupled to one or more video cameras 248-1, 248-2, 248-n placed at locations within the POS location where a customer's face may be detected. In the example shown in FIG. 2, the information handling system 200 is operatively coupled to three video cameras 248-1, 248-2, 248-n. However, the present specification contemplates that more or less than three video cameras 248-1, 248-2, 248-n at locations that will facilitate the operations of the systems and methods described herein. For example, at least one of the video cameras 248-1, 248-2, 248-n may be located at a sales counter and directed towards a location where a customers' face will be viewable by the video cameras 248-1, 248-2, 248-n. The embodiments described herein further contemplate that the video cameras 248-1, 248-2, 248-n form part of an information handling system 200 used by a customer to engage in ecommerce activities. For example, the information handling system 200 may be a smartphone, tablet, or other handheld device that includes a video camera 248-1, 248-2, 248-n and through which the user engages in the purchase of goods such as via an online marketplace or engages in online activities such as viewing a purchased movie, playing online games, engaging in a telemedicine call with a doctor, among other online activities. In these embodiments, the video cameras 248-1, 248-2, 248-n may provide the video images to the facial recognition system 226 as described herein. In these embodiments, the user may allow access by the facial recognition system 226 to a camera driver associated with the video cameras 248-1, 248-2, 248-n such that these video images may be provided as described.

As described herein, the facial recognition system 226 may detect, with a facial recognition module 228, the face of a customer from a video image produced by the one or more video cameras 248-1, 248-2, 248-n. In an embodiment, a digital video recorder 246 may be used to records video in a digital format to a disk drive, a USB flash drive, a SD memory card, an SSD or other local data storage device. The detection of the face of the customer may be performed by, for example, executing a feature-based facial detection process or an image-based facial detection on those video images stored by the digital video recorder 246. In the context of the embodiments described herein, a facial recognition neural network 232 is used. In these embodiments, the facial recognition neural network 232, in an embodiment, may be an untrained neural network that learns, holistically, how to detect and extract faces from the video images. The neural network may implement any machine learning techniques such as a supervised or unsupervised machine learning technique to identify faces within the video image as described herein. In an embodiment, a neural network of the facial recognition system 226 may be separately trained for each information handling system (e.g., including 200) used to detect the presence and identity of a customer. The facial recognition neural network 232 may receive, as input, a plurality of video images either from the video cameras 248-1, 248-2, 248-n at the POS location or from a databased accessible by the information handling system 200. In an alternative embodiment, the facial recognition neural network 232 may be a trained neural network received from a computing device remote from the information handling system 200 and maintained on a data storage device thereon. Please include that our program is not limited to video captured from the cameras but it can process any videos submitted to it

In an embodiment, once the face within a video image has been detected, the face may be tracked over a plurality of video images as the customer travels throughout the POS location using the facial recognition system 226. As this occurs, the facial recognition system 226 may also execute a face alignment process that normalizes the face using geometry and photometrics processes. This normalization of the customer's face may then allow the facial recognition system 226 to extract features from the detected faces that are used later to recognize a customer as either a new customer or a repeat customer at the POS location.

The extracted facial features may include any number of distinctive features of any users' face that are distinguishable among facial images and among customers. In this embodiment, the facial recognition system 226 may identify facial features by extracting landmarks, or features, from an image of the subject's face. The information handling system 200, as mentioned, may include a low-resolution facial encrypted array creation module 230. The low-resolution facial encrypted array creation module 230 may, according to the present description, perform tasks related to generating a low-resolution facial encrypted array of each of the faces of the customers detected at the POS location. In an embodiment, the extracted features of each of the customers' faces may be used to create these low-resolution facial encrypted arrays as described herein.

At this point, the stored low-resolution facial encrypted arrays stored on the low-resolution facial encrypted array database 234, maintained on a computer readable medium 222, are not associated with a specific customer detected by the information handling system 200. In an embodiment, these low-resolution facial encrypted arrays may be associated with a specific customer via execution of the cross-referencing module 238. In this embodiment, the cross-referencing module 238 may receive POS data describing the individual customers' names at the time of purchase of a good or service at the POS location. This cross-referencing may be accomplished by noting the time the transaction took place between the customer and the POS location as well as the time stamp of the video image used to extract the facial features and generate the low-resolution facial encrypted arrays with. At this point the low-resolution facial encrypted array database 234 may store the individual customers' along with the detected low-resolution facial encrypted arrays associated with those customers. This allows the information handling system 200 to execute the facial recognition system 226 and cross-referencing module 238 concurrently in order to compare any detected facial features (e.g., any created low-resolution facial encrypted arrays) with those maintained on the low-resolution facial encrypted array database 234 to determine whether the detected face of the customer is new to the POS location or a returning customer. in an embodiment where no cross-referencing may be accomplished by the system in order to identify a specific low-resolution facial encrypted array with a specific identification of that user, the facial recognition system 226 and cross-referencing module 238 may still identify if a customer is a returning customer or a new customer. The POS/emotion cross-referencing module 238 may be used to accomplish this process. In this embodiment, the POS/emotion cross-referencing module 238 may identify a returning customer by matching a low-resolution facial encrypted array obtained at the point of identification by the facial recognition system 226 with another low-resolution facial encrypted array stored on the low-resolution facial encrypted array database 234. Where a match exists, the customer is indicated as a returning customer. Where no such match is obtained, the customer is indicated as a new customer. In an embodiment, the use of promotional items for any customer may vary and depend on whether the customer is a returning customer or a new customer. In an embodiment, the low-resolution facial encrypted arrays may be maintained during the length of operation of the information handling system 200. In alternative embodiments, some low-resolution facial encrypted arrays may be deleted after a threshold period of time to provide additional storage at the low-resolution facial encrypted array database 234 and reduce the number of low-resolution facial encrypted arrays to compare any subsequently-created low-resolution facial encrypted arrays with.

The information handling system 200, as mentioned, may include a demographics database 236 that may be operably connected to the bus. The demographics database 236 may, according to the present description, receive demographic data associated with each customer as determined by the facial recognition system 226 and low-resolution facial encrypted array creation module 230. In a specific, embodiment, the facial recognition neural network 232 of the facial recognition system 226 may be trained to determine whether the detected faces include, for example, a male or female. The facial recognition neural network 232 may also determine a general age of the customer in an embodiment. Still further, the facial recognition neural network 232 may determine any other relevant demographics that may aid the user of the information handling system 200 to increase sales at the POS location.

In another embodiment, the data created by the low-resolution facial encrypted array creation module 230 may be used to determine these demographics of the customers based on the extracted facial features and created low-resolution facial encrypted arrays. In this embodiment, the extracted low-resolution facial encrypted arrays may indicate which gender or age the customer is along with these other demographics.

The information handling system 200, as mentioned, may include a POS/emotion cross-referencing module 238. The POS/emotion cross-referencing module 238 may, according to the present description, perform tasks related to determining a customer's emotion during a transaction at the POS location. In an embodiment, the video cameras 248-1, 248-2, 248-n may detect the face of a customer while the customer is within the POS location, actively talking with an employee of the POS location, and/or engaged in a transaction such as an over-the-counter transaction. In this embodiment, the POS/emotion cross-referencing module 238 may implement the features of the facial recognition neural network 232 to extract a detected emotion from the video images presented by the video cameras 248-1, 248-2, 248-n at any time while the customer is in the POS location. This may be done by, again, by using the individual video images as input into the facial recognition neural network 232 and receiving, as output, a detected emotion. Again, the video images may form the input layer of the neural network. These input layers may be forward propagated through the neural network to produce an initial output layer that includes predicted emotions of the customer or customers within the video images. Each of the output nodes within the output layer, in an embodiment, may be compared against such known values (e.g., images known to include specific emotions of a customer) to generate an error function for each of the output nodes. This error function may then be back propagated through the neural network to adjust the weights of each layer of the neural network. The accuracy of the predicted meeting metric values (as represented by the output nodes) may be optimized in an embodiment by minimizing the error functions associated with each of the output nodes. Such forward propagation and backward propagation may be repeated serially during training of the neural network, adjusting the error function during each repetition, until the error function for all of the output nodes falls below a preset threshold value. In other words, the weights of the layers of the neural network may be serially adjusted until the output node for each of the video images accurately predicts the presence of one or more emotions of a customer within the video image. In such a way, the neural network may be trained to provide the most accurate output layer, including a prediction of the existence of emotions experienced by the customer in order to gauge how the customer is feeling within the POS location. In these embodiments, the emotions of the customers may indicate to an owner of the POS location and operator of the information handling system that a customer is angry for some reason (e.g., poor customer service, high prices, etc.), disgusted, fearful, happy, neutral, sad, or surprised among a plurality of other possible emotions. Again, the training of the facial recognition neural network 232 may dictate the accuracy of the emotions detected and as the facial recognition neural network 232 is trained, this accuracy may increase. As such, the information handling system 200 may increase the accuracy at which it detects the facial features of a customer as well as the emotions of those customers. In an embodiment, once the emotions of the customers are detected, the emotions experienced by each individual customer throughout the customers' presence within the POS location.

The information handling system 200 includes a video deletion module 240. In order to maintain privacy related to the customer's, the video deletion module 240 may delete any video images or video content that includes an image of the customers. In this embodiment, the facial recognition neural network 232 may send a signal to the video deletion module 240 that the low-resolution facial encrypted array creation module 230 has created the low-resolution facial encrypted arrays and stored those low-resolution facial encrypted arrays on the low-resolution facial encrypted array database 234. When this occurs, the information handling system 200 maintains sufficient information to recognize a new or returning customer by comparing any newly created low-resolution facial encrypted arrays to those stored on the low-resolution facial encrypted array database 234. Because, in an embodiment, the low-resolution facial encrypted arrays are encrypted using any encryption method, the low-resolution facial encrypted arrays may not be accessed by any other networked device without having access to, for example, a decryption key. When the video deletion module 240 receives this signal that these low-resolution facial encrypted arrays have been created and stored, the video deletion module 240 may delete any and all video images and notify the facial recognition system 226 that this has occurred. Again, this protects any customers' privacy while still allowing a user and owner of the information handling system 200 to receive demographic data and emotion data associated with each customer.

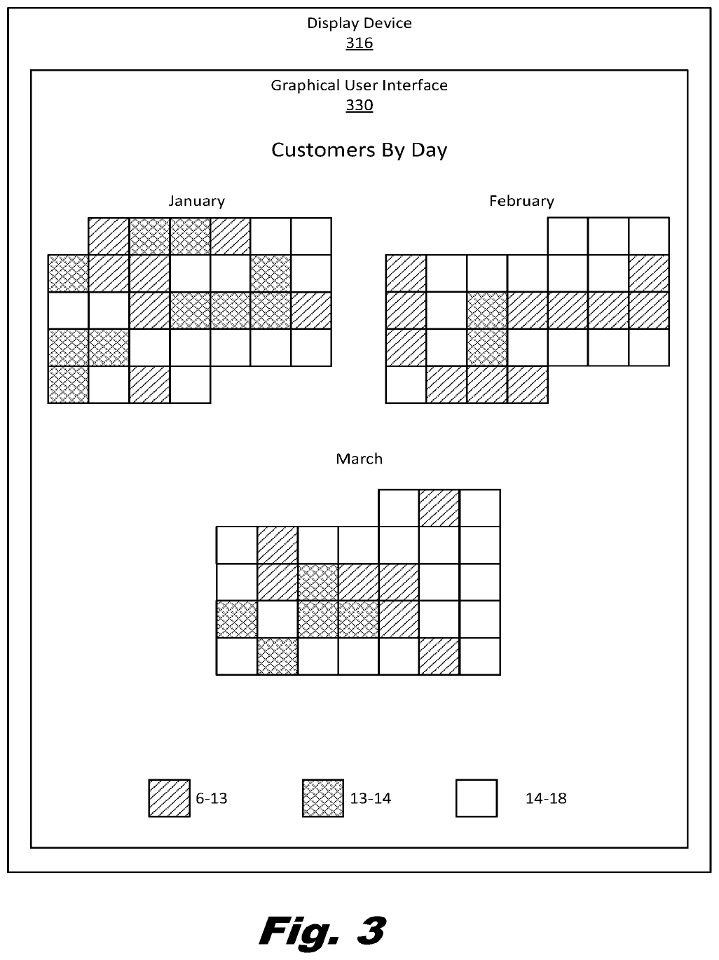

The information handling system 200 may further include a display device 216 that may present a GUI 220 to a user of the information handling system. As described herein, the GUIs 220 may include the demographic data, emotion data, among other date. Specific examples of GUIs that may be displayed are discussed in connection with FIGS. 3-8.

FIGS. 3-8 each depict an example graphical user interface (GUI) that may be presented to a user of the information handling system described herein in order to provide demographic data, customer visit data over time, and emotion data as described herein. Each of the GUIs 330, 430, 530, 630, 730, 830 may be presented on a display device 316, 416, 516, 616, 716, 816. The present specification contemplates that the arrangement of the data presented via the GUIs 330, 430, 530, 630, 730, 830 may be varied while the data presented may be similar to that described. The present specification further contemplates that additional data may be presented to the user.

FIG. 3 is a block diagram depicting a GUI 330 on a display device 316 presented to a user during operation of the information handling system according to an embodiment of the present disclosure. In this embodiment, a calendar or one or more calendars of months of the year are presented to a user of the information handling system. In this embodiment, each day of each month may be color coded or otherwise distinguished between other days so as to depict a range of customers that visited the POS location those days. In this embodiment, a first range may be between 6-13 customers, a second range may be 13-14 customers, and a third range may be 14-18 customers. With this data, the user of the information handling system may determine whether, for example, any improvements at the POS location have resulted in any additional customers. The present specification contemplates, however, that these ranges of visiting customers may be different than what is shown in FIG. 3.

In an embodiment, each day represented on each calendar may have a number associated with it descriptive of the exact number of unique customers that visited that day along with other distinguishing features. In this embodiment, the uniqueness of each customer is determined by the execution of the facial recognition system along with the low-resolution facial encrypted array creation module and POS/emotion cross-referencing module as described herein. In this embodiment, as each unique customer is identified the number associated with the day of the week is increased by one. In an embodiment, the number of unique customers may be descriptive of the number of times a customer visits the POS location in a day regardless of whether that user had visited the store multiple times that day. For example, the information handling system may execute the facial recognition system such that when a unique face is detected, the low-resolution facial encrypted arrays are compared to the newly created low-resolution facial encrypted array created from the new customers face and, if the customer had visited the POS location earlier that day, a threshold time duration is enabled. This threshold time duration may mark the second visit by the same customer as a unique customer visit when the duration between the first visit and the second visit meets or exceeds that time duration threshold. This may prevent multiple entries from a single customer from adding to the count in the day when, for example, that customer had left for only a few minutes to access something out of the customer's car, but returned to complete the transactions at the POS location.

The data presented for each day in the GUI 330 may also indicate whether that unique customer is a returning customer from a previous day or is a new customer who had never visited the POS location before. This would better identify to the user of the information handling system that certain advertising campaigns, for example, are resulting in additional foot traffic at the POS location.

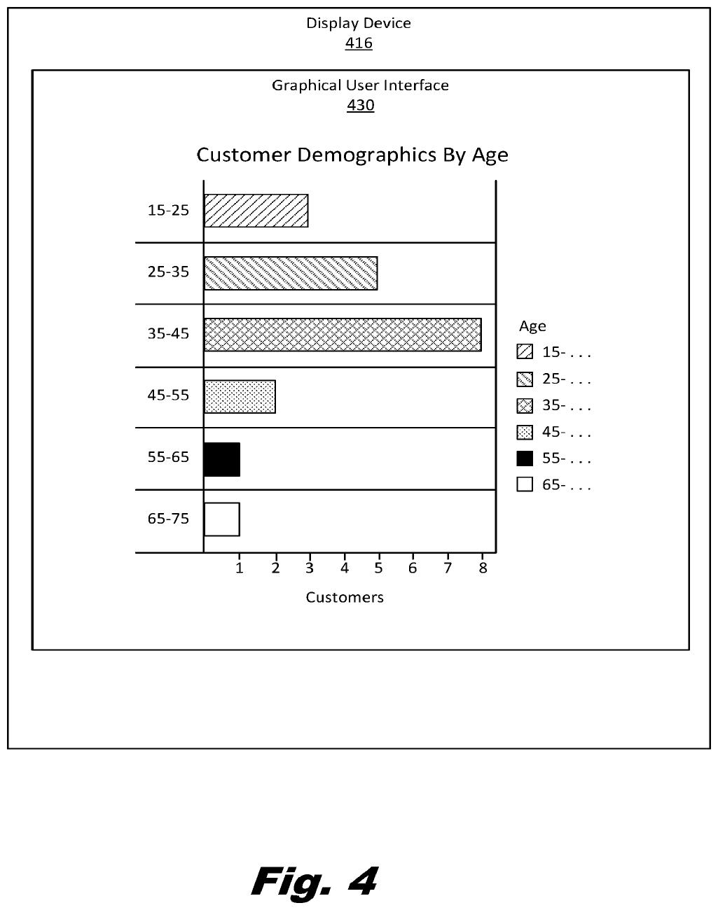

FIG. 4 is a block diagram depicting a GUI 430 presented to a user on a display device 416 during operation of the information handling system according to another embodiment of the present disclosure. The GUI 430 in FIG. 4 depicts a graph describing the customer demographics by ages in the form of age ranges. In this example, these age ranges are depicted as 15-25-year-olds, 25-35-year-olds, 35-45-year-olds, 45-55-year-olds, 55-65-year-olds, and 65-75-year-olds. Although specific age ranges are depicted in FIG. 4, the present specification contemplates the use of other age ranges that may result in an increase or decrease in the number of ranges used.

The data presented in the GUI 430 is, as described herein, generated through the execution of the facial recognition system, the facial recognition neural network, and low-resolution facial encrypted array database as described herein. In these embodiments, the facial recognition system may execute the facial recognition neural network in order to provide an indication of a face on a video frame. The low-resolution facial encrypted array creation module may create a number of low-resolution facial encrypted arrays that describe a customer's face. From the low-resolution facial encrypted arrays, the age of the customer may be detected and provided as part of the information presented on the GUI 430. In an embodiment, certain features found in the low-resolution facial encrypted arrays may indicate a state of the user's skin, soft tissue and any underlying bone structure and thereby may indicate the customer's age.

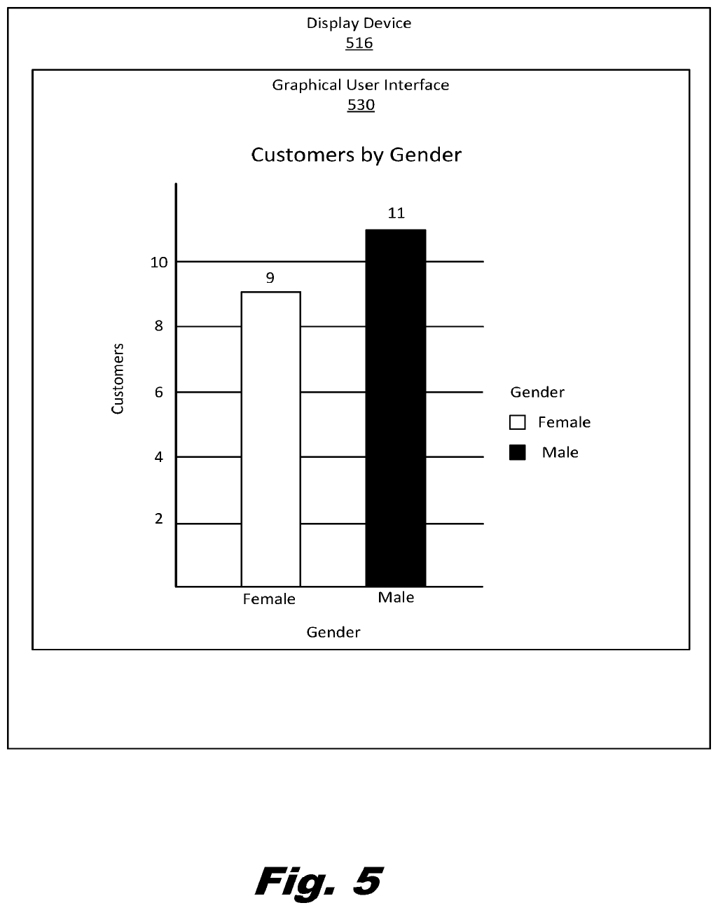

FIG. 5 is a block diagram depicting a GUI 530 representing customers by gender and presented to a user during operation of the information handling system according to another embodiment of the present disclosure. In these embodiments, the facial recognition system may execute the facial recognition neural network in order to provide an indication of a face on a video frame. The low-resolution facial encrypted array creation module may create a number of low-resolution facial encrypted arrays that describe a customer's face. From the low-resolution facial encrypted arrays, the gender of the customer may be detected and provided as part of the information presented on the GUI 530. In an embodiment, certain features found in the low-resolution facial encrypted arrays may indicate any underlying bone structure or other facial features that indicate one gender or another. The genders depicted in FIG. 5 may indicate a specific number of each gender as well as the bars used to indicate those numbers on the graph.

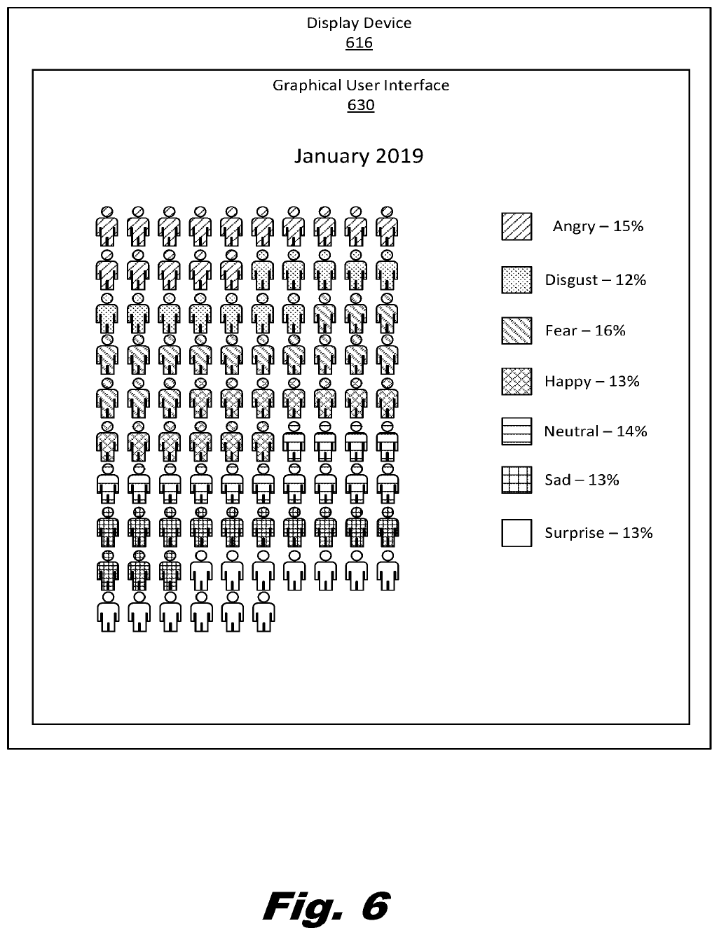

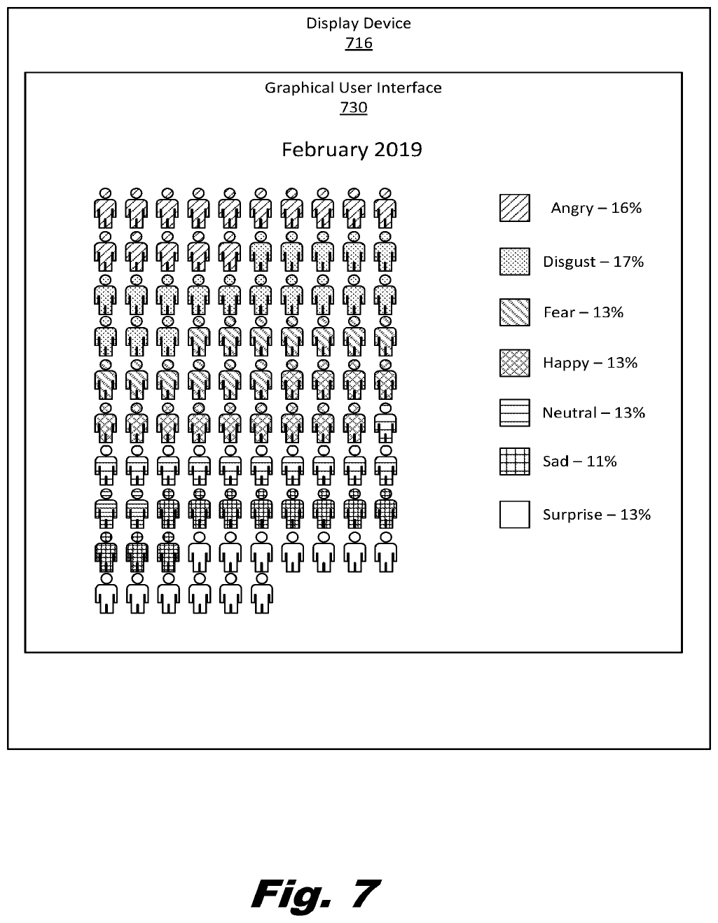

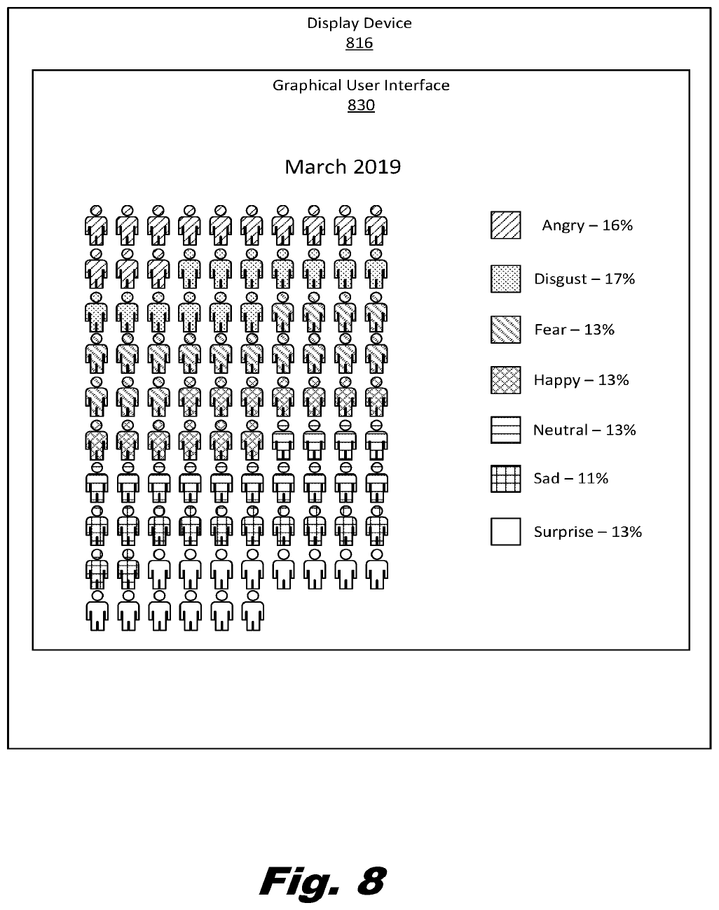

FIGS. 6, 7, and 8 are block diagrams depicting a GUI 630, 730, 830 presented to a user during operation of the information handling system according to another embodiment of the present disclosure. The GUI 630, 730, and 830 each depict a number of users who have been determined to have certain emotions associated with them such as anger, disgust, fear, happiness, neutral, sadness, and surprise. FIG. 6 shows this data for January 2019, FIG. 7 shows this data for February 2019, and FIG. 8 shows this data for March 2019.

Each customer detected during a given month is depicted in these GUIs 630, 730, 830 as an image of a silhouette of a person. However, other depictions may be used and the present specification contemplates these other images. In an embodiment, a single silhouette of a person may be equal to one or more unique customers that visited that POS location during the month. Whether the silhouettes of a person are used to represent one or a plurality of unique customers, each silhouette may be shaded or colored according to the emotions detected by the information handling system and associated with the customer or customers. In these embodiments, the facial recognition system may execute the facial recognition neural network in order to provide an indication of a face on a video frame. The low-resolution facial encrypted array creation module may create a number of low-resolution facial encrypted arrays that describe a customer's face. From the low-resolution facial encrypted arrays, the emotion of the customers may be detected and provided as part of the information presented on the GUIs 630, 730, 830. In an embodiment, certain features found in the low-resolution facial encrypted arrays may indicate any muscular orientations other facial features that indicate one emotion or another. The emotions depicted in FIGS. 6, 7, and 8 may indicate a specific number of each emotion felt by a customer as in order to notify the user of the information handling system according to the principles described herein.

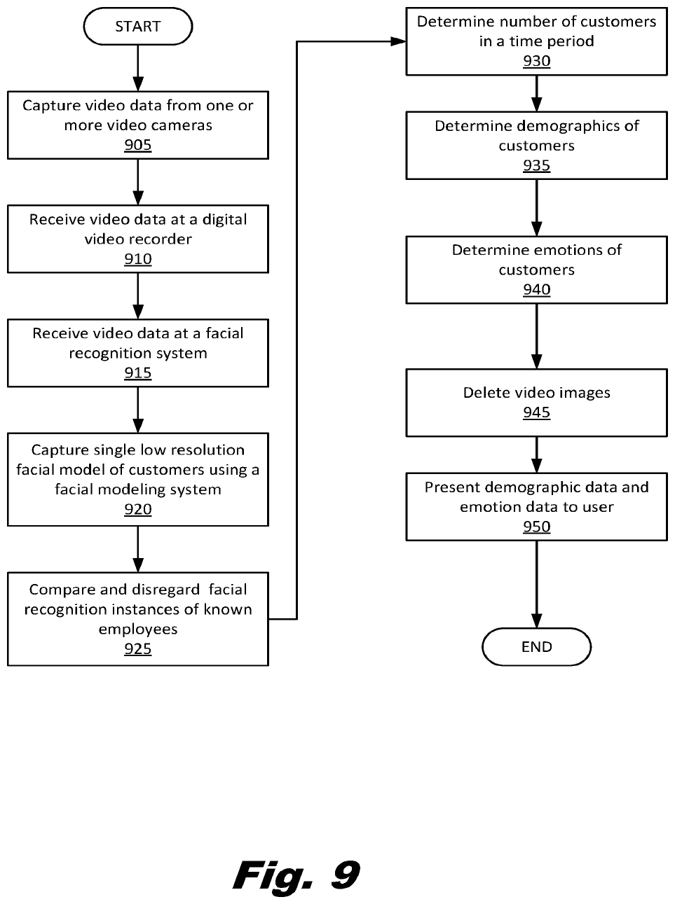

FIG. 9 is a flow diagram illustrating a method 900 of monitoring point-of-sale (POS) contact according to an embodiment of the present disclosure. The method 900 may be conducted in order to determine various demographics and emotions associated with each unique customer detected by the information handling system as described herein.

The method 900 may begin at block 905 with capturing video data from one or more video cameras. As described herein, the information handling system may be part of a system that receives video feeds from a plurality of video cameras distributed throughout the POS location so that images of customers may be captured. In an embodiment, the video cameras may be oriented to achieve the best images of the customers so that the data associated with these images may be evaluated.

The method 900 may include, at block 910, with receiving the video data (e.g., video images or streaming video) at a digital video recorder. In an embodiment, a digital video recorder may be used to records video in a digital format to a disk drive, a USB flash drive, a SD memory card, an SSD or other local data storage device. In an embodiment, the digital video recorder may separate the video streams into individual video images so that each image may be consumed by the facial recognition system as described herein.

The method 900 may further include receiving that video data (e.g., video images) at the facial recognition system at block 915. The facial recognition system may, according to the present description, perform tasks related to receiving video data or images from one or more video cameras and executing a low-resolution facial encrypted array creation module to create a low-resolution facial encrypted array describing features of any customer at the POS location described herein. In creating the low-resolution facial encrypted arrays, the demographics of the customer at the POS location may also be determined. The facial recognition system may also execute a POS/emotion cross-referencing module that determines an emotion of a customer at the POS location.

In an embodiment, the facial recognition system may detect the face of a customer from a video image. The detection of the face of the customer may be performed by, for example, executing a feature-based facial detection process or an image-based facial detection. The feature-based facial detection process may include one or more image filters that search for and locate faces in a video image (e.g., a video frame) using, for example, a principal component analysis. In this embodiment, a number of “eigenfaces” are determined based on global and orthogonal features in other known images that include human faces. A human face may then be calculated as a weighted combination of a number of these eigenfaces.

Alternatively, and in the context of the embodiments described herein, a facial recognition neural network is used. In these embodiments, the facial recognition neural network, in an embodiment, may be an untrained neural network that learns, holistically, how to detect and extract faces from the video images. The neural network may implement any machine learning techniques such as a supervised or unsupervised machine learning technique to identify faces within the video image. In an embodiment, a neural network of the facial recognition system may be separately trained for each information handling system used to detect the presence and identity of a customer. The facial recognition neural network may receive, as input, a plurality of video images either from the video camera at the POS location or from a databased accessible by the information handling system.

Training of the facial recognition neural network may include inputting the video images into the facial recognition neural network that includes a plurality of layers, including an input layer, one or more hidden layers, and an output layer. The video images may form the input layer of the neural network in an embodiment. These input layers may be forward propagated through the neural network to produce an initial output layer that includes predicted faces within the video images. Each of the output nodes within the output layer, in an embodiment, may be compared against such known values (e.g., images known to have faces) to generate an error function for each of the output nodes. This error function may then be back propagated through the neural network to adjust the weights of each layer of the neural network. The accuracy of the predicted meeting metric values (as represented by the output nodes) may be optimized in an embodiment by minimizing the error functions associated with each of the output nodes. Such forward propagation and backward propagation may be repeated serially during training of the neural network, adjusting the error function during each repetition, until the error function for all of the output nodes falls below a preset threshold value. In other words, the weights of the layers of the neural network may be serially adjusted until the output node for each of the video images accurately predicts the presence of a face in the video image. In such a way, the neural network may be trained to provide the most accurate output layer, including a prediction of the existence of a face in the video image.

In an embodiment, the facial recognition neural network may be trained prior to deployment in the information handling system. In this embodiment, the trained facial recognition neural network may be trained by an information handling system that is operatively coupled to the information handling system deployed at the POS location via a network. In this embodiment, the trained facial recognition neural network may be updated occasionally to increase the efficiency of the execution of the facial recognition neural network.

In an embodiment, once the face within a video image has been detected, the face may be tracked over a plurality of video images as the customer travels throughout the POS location using the facial recognition system. As this occurs, the facial recognition system may also execute a face alignment process that normalizes the face using geometry and photometrics processes. This normalization of the customer's face may then allow the facial recognition system to extract features from the detected faces that are used later to recognize a customer as either a new customer or a repeat customer at the POS location.

The method 900 may include, at block 920, capturing a single low-resolution facial model of each customer using a facial modeling system. This facial modeling system may, in an embodiment, include the low-resolution facial encrypted array creation module described in connection with FIG. 1. This low-resolution facial encrypted array creation module may, according to the present description, perform tasks related to generating a low-resolution facial encrypted array of each of the faces of the customers detected at the POS location. In an embodiment, the extracted features of each of the customers' faces may be used to create these low-resolution facial encrypted arrays. For example, the arrays may include distance and vector values that define the features and placement of those features of each customer's face. These distance and vector values may be stored on a low-resolution facial encrypted array database for future use by the information handling system.

The method may then continue at block 925 with comparing and disregarding facial recognition instances of known employees. In an embodiment, the facial recognition system with its facial recognition neural network may also detect the presence of an employee of the POS location. This data may be deliberately added to the low-resolution facial encrypted array database after the facial recognition system has created the low-resolution facial encrypted arrays of the employees' faces via the low-resolution facial encrypted array creation module. In these examples, the POS/emotion cross-referencing module may be implemented to disregard the emotions detected and demographics associated with these employees so that only data from customers visiting the POS location is received and provided to the user of the information handling system (e.g., an owner/operator of the POS location).

In an embodiment where the facial recognition system includes an untrained facial recognition neural network, the emotions of the employees may also be extracted with the creation of a low-resolution facial encrypted array. In this embodiment, the low-resolution facial encrypted array database may maintain these detected emotions and low-resolution facial encrypted array. During operation of the information handling system, the low-resolution facial encrypted arrays associated with the employees may be filtered out so that the data presented on the GUIs described herein do not include this data associated with the employees. In this embodiment, the low-resolution facial encrypted arrays associated with the employees may also be used to further train the facial recognition neural network in order to receive better output results.

The method 900 may also include determining a number of customers in a given time period at block 930. The time period may be minuets, hours, days, or months as described in any timestamp associated with the video images (e.g., millisecond differences may be detectable). As described herein, the uniqueness of each customer, and therefore an accurate number of customers, is determined by the execution of the facial recognition system along with the low-resolution facial encrypted array creation module and POS/emotion cross-referencing module as described herein. In an embodiment, the number of unique customers may be descriptive of the number of times a customer visits the POS location in a day regardless of whether that user had visited the store multiple times that day. For example, the information handling system may execute the facial recognition system such that when a unique face is detected, the low-resolution facial encrypted arrays are compared to the newly created low-resolution facial encrypted array created from the new customers face and, if the customer had visited the POS location earlier that day, a threshold time duration is enabled. This threshold time duration may mark the second visit by the same customer as a unique customer visit when the duration between the first visit and the second visit meets or exceeds that time duration threshold. This may prevent multiple entries from a single customer from adding to the count in the day when, for example, that customer had left for only a few minutes to access something out of the customer's car, but returned to complete the transactions at the POS location. Alternatively, separate metrics may be recorded if the same customer is detected on the same day such that the data may be used to determine different purposes to the customer's return.

The method 900 may also include, at block 935, determining the demographics of the customers. As described herein, these demographics may include gender and age of the customers among other types of demographics. In a specific, embodiment, the facial recognition neural network of the facial recognition system may be trained to determine whether the detected faces include, for example, a male or female. The facial recognition neural network may also determine a general age of the customer in an embodiment. Still further, the facial recognition neural network may determine any other relevant demographics that may aid the user of the information handling system to increase sales at the POS location.

In another embodiment, the data created by the low-resolution facial encrypted array creation module may be used to determine these demographics of the customers based on the extracted facial features and created low-resolution facial encrypted arrays. In this embodiment, the extracted low-resolution facial encrypted arrays may indicate which gender or age the customer is along with these other demographics. For example, certain measurements in the data of the low-resolution facial encrypted arrays may be used to distinguish between male and female features of the customers' faces. Although, in some embodiments, this may not be definitive of which demographics to assign to each customer, the data received from the low-resolution facial encrypted arrays may assign a probability of certain demographics of an individual customer which, with the output from the facial recognition neural network, may determine the demographics of the individual customers more accurately.

The method 900 also includes determining the emotions of the customers at block 940. As described herein, the information handling system may include a POS/emotion cross-referencing module. The POS/emotion cross-referencing module may, according to the present description, perform tasks related to determining a customer's emotion during a transaction at the POS location or during any other time while the customer is within the POS location. In an embodiment, the video camera may detect the face of a customer while the customer is within the POS location, actively talking with an employee of the POS location, and/or engaged in a transaction such as an over-the-counter transaction. In this embodiment, the POS/emotion cross-referencing module may implement the features of the facial recognition neural network to extract a detected emotion from the video images presented by the video camera at any time while the customer is in the POS location. This may be done by, again, using the individual video images as input into the facial recognition neural network and receiving, as output, a detected emotion. Again, the video images may form the input layer of the neural network. These input layers may be forward propagated through the neural network to produce an initial output layer that includes predicted emotions of the customer or customers within the video images. Each of the output nodes within the output layer, in an embodiment, may be compared against such known values (e.g., images known to include specific emotions of a customer) to generate an error function for each of the output nodes. This error function may then be back propagated through the neural network to adjust the weights of each layer of the neural network. The accuracy of the predicted meeting metric values (as represented by the output nodes) may be optimized in an embodiment by minimizing the error functions associated with each of the output nodes. Such forward propagation and backward propagation may be repeated serially during training of the neural network, adjusting the error function during each repetition, until the error function for all of the output nodes falls below a preset threshold value. In other words, the weights of the layers of the neural network may be serially adjusted until the output node for each of the video images accurately predicts the presence of one or more emotions of a customer within the video image. In such a way, the neural network may be trained to provide the most accurate output layer, including a prediction of the existence of emotions experienced by the customer in order to gauge how the customer is feeling within the POS location. In these embodiments, the emotions of the customers may indicate to an owner of the POS location and operator of the information handling system that a customer is angry for some reason (e.g., poor customer service, high prices, etc.), disgusted, fearful, happy, neutral, sad, or surprised among a plurality of other possible emotions. Again, the training of the facial recognition neural network may dictate the accuracy of the emotions detected and as the facial recognition neural network is trained, this accuracy may increase. As such, the information handling system may increase the accuracy at which it detects the facial features of a customer as well as the emotions of those customers. In an embodiment, once the emotions of the customers are detected, the emotions experienced by each individual customer throughout the customers' presence within the POS location.

The method 900 may also include deleting the video images provided from the video cameras to the information handling system at block 945. In the embodiments herein, in order to maintain privacy related to the customer's, a video deletion module may be used to delete any video images or video content that includes an image of the customers. In this embodiment, the facial recognition neural network may send a signal to the video deletion module that the low-resolution facial encrypted array creation module has created the low-resolution facial encrypted arrays and stored those low-resolution facial encrypted arrays on the low-resolution facial encrypted array database. When this occurs, the information handling system maintains sufficient information to recognize a new or returning customer by comparing any newly created low-resolution facial encrypted arrays to those stored on the low-resolution facial encrypted array database. Because, in an embodiment, the low-resolution facial encrypted arrays are encrypted using any encryption method, the low-resolution facial encrypted arrays may not be accessed by any other networked device without having access to, for example, a decryption key. When the video deletion module receives this signal that these low-resolution facial encrypted arrays have been created and stored, the video deletion module may delete any and all video images and notify the facial recognition system that this has occurred.

The method 900, at block 950, may also include presenting the demographic data and emotion data to the user of the information handling system. This data may be presented to the user via a display device. The display device may present to the user any number and type of GUI on the display device that describe this data. Example GUIs are represented in FIGS. 3-8 herein. Each of these GUIs may represent real-time and historic data related to the demographics and emotions of the customers as they enter the POS location. At this point, the method 900 may end.

The blocks of the flow diagrams of FIG. 9 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system, comprising:
a processor;
a memory;
a power management unit to provide power to the information handling system;
a video camera to acquire video images of a customer at a point-of-sale (POS) location;
a facial recognition system to execute a facial recognition module at the POS location to detect the face of the customer and determine an emotion of the customer;
a video deletion module to delete the video images of the customer when the face of the customer is detected and the emotion is determined.

2. The information handling system of claim 1 further comprising a neural network to receive the video images of the customer as input and provide, as output, the determined emotion of the customer.

3. The information handling system of claim 1 further comprising a neural network to receive the video images of the customer as input and provide, as output, demographic data describing the customer.

4. The information handling system of claim 1 further comprising a low-resolution facial encrypted array database to maintain:
an encrypted array of one or more employees within the POS location;
an encrypted array of each customer to have their face detected by the facial recognition system.

5. The information handling system of claim 1 further comprising a display device to display a graphical user interface (GUI) to present to a user of the information handling system:
a graphic describing a calendar with one or more days indicating a number of unique customers detected by the facial recognition system;
a graphic describing age demographics of customers detected by the facial recognition system over a period of time;
a graphic describing gender demographics of customers detected by the facial recognition system over a period of time;
a graphic describing determined emotions of the customers over a period of time; or
a combination thereof.

6. The information handling system of claim 1 further comprising a POS/emotion cross-referencing module to associate, based on POS data, customer data with an emotion felt by the user at the POS.

7. The information handling system of claim 1, the facial recognition system to determine a distance between one or more employees and the customer and, when a threshold distance is met, indicating that a discussion has occurred and detecting the face of the customer and determining the emotion of the customer.

8. A method of monitoring point-of-sale (POS) contact comprising:
with a processor, activating a video camera to acquire video images of a customer at a point-of-sale (POS) location;
a facial recognition system to, when executed by the processor, initiate a facial recognition module at the POS location to detect the face of the customer and determine an emotion of the customer;
a video deletion module to delete the video images of the customer when the face of the customer is detected and the emotion is determined.

9. The method of claim 8 further comprising inputting video images of the customer into a neural network to receive, as output, demographic data describing the customer.

10. The method of claim 8 further comprising inputting video images of the customer into a neural network to receive, as output, the determined emotion of the customer.

11. The method of claim 8 further comprising, with a low-resolution facial encrypted array database, maintaining:
an encrypted array of one or more employees within the POS location;
an encrypted array of each customer to have their face detected by the facial recognition system;
the facial recognition system to disregard the encrypted array of each employee while executing the facial recognition module.

12. The method of claim 8 further comprising presenting, on a display device, a graphical user interface (GUI) to a user of the information handling system:
a graphic describing a calendar with one or more days indicating a number of unique customers detected by the facial recognition system;
a graphic describing age demographics of customers detected by the facial recognition system over a period of time;
a graphic describing gender demographics of customers detected by the facial recognition system over a period of time;
a graphic describing determined emotions of the customers over a period of time; or a combination thereof.

13. The method of claim 8 further comprising, with a POS/emotion cross-referencing module, associating customer data with an emotion felt by the user at the POS based on POS data.

14. The method of claim 8 further comprising determining, with the facial recognition system, a distance between one or more employees and the customer and, when a threshold distance is met, indicating that a discussion has occurred and detecting the face of the customer and determining the emotion of the customer.

15. An information handling system, comprising:
a processor;
a memory;
a power management unit to provide power to the information handling system;
a video camera to acquire video images of a customer at a point-of-sale (POS) location;
a facial recognition system to execute a facial recognition module at the POS location to detect the face of the customer and determine an emotion of the customer;
a low-resolution facial encrypted array database to maintain:
an encrypted array of one or more employees within the POS location the encrypted array describing physical features of the employee;
an encrypted array of each customer to have their face detected by the facial recognition system the encrypted array describing physical features of each of the customers;
a video deletion module to delete the video images of the customer when the face of the customer is detected and the emotion is determined.

16. The information handling system of claim 15 further comprising a neural network to receive the video images of the customer as input and provide, as output, the determined emotion of the customer.

17. The information handling system of claim 15 further comprising a neural network to receive the video images of the customer as input and provide, as output, demographic data describing the customer.

18. The information handling system of claim 15 the facial recognition system executed to disregard the encrypted array of each employee while executing the facial recognition module.

19. The information handling system of claim 15 further comprising a display device to display a graphical user interface (GUI) to present to a user of the information handling system:
a graphic describing a calendar with one or more days indicating a number of unique customers detected by the facial recognition system;
a graphic describing age demographics of customers detected by the facial recognition system over a period of time;
a graphic describing gender demographics of customers detected by the facial recognition system over a period of time;
a graphic describing determined emotions of the customers over a period of time; or a combination thereof.

20. The information handling system of claim 15 further comprising a POS/emotion cross-referencing module to associate, based on POS data, customer data with an emotion felt by the user at the POS.
